(19) United States
(12) Patent Application Publication
(10) Pub. No.: US 2007/0296818 A1
(43) Pub. Date: Dec. 27, 2007

(54) Audio/visual Apparatus With Ultrasound

(75) Inventor: Gunjan Porwal, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,920

(22) PCT Filed: Aug. 17, 2005
(86) PCT No.: PCT/IB05/52710

§ 371 Date: Feb. 19, 2007

(30) Foreign Application Priority Data
Aug. 31, 2004 (EP) 04104177.3

(51) Int. Cl. G01S 15/89

(52) U.S. Cl. 348/163

(57) ABSTRACT

An audio/visual system comprises a display device (1) to display a plurality of different video signals (V1, V2) which have different video content. An audio processor (4) receives a plurality of audio input signals (AI1, AI2) representing corresponding different base-band audio content, wherein each one of the different audio input signals (AI1, AI2) corresponds to a corresponding one of the plurality of different video signals (V1, V2). The audio processor (4) modulates the audio input signals (AI1, AI2) on corresponding sets (Si) of a first and a second ultrasonic drive signal (S1i, S2i) which have a difference frequency which is the corresponding base-band audio content. A plurality of ultrasonic sources (5, 6), receives the corresponding sets (Si) of first and second ultrasonic drive signals (S1i, S2i), respectively, to supply a plurality of ultrasonic beams (Bi) conveying the plurality of different audio input signals (AI1, AI2). At least a subset of the ultrasonic sources (5, 6) are positioned with respect to each other to direct the different ultrasonic beams (Bi) of the ultrasonic sources (5, 6) of the subset to different listening positions (P1, P2).

The invention relates to an audio/visual system comprising a display device, an audio processor and a plurality of ultrasonic sources, and to a method of supplying sets of ultrasonic drive signals to a plurality of associated ultrasonic sources which have different locations and/or directions with respect to each other.

U.S. Pat. No. 5,099,365 discloses a circuit which simultaneously generates the sounds of both a main picture and a sub-picture for a PIP (picture in picture) system. While one person listens to the sound of the main picture through the TV monitor, another person listens to the sound of the sub-picture through a headphone.

However, many people consider a headphone to be a nuisance.

It is an object of the invention to provide an audio system which presents different audio content to corresponding different listener positions without requiring a headphone.

A first aspect of the invention provides an audio/visual system as claimed in claim 1. A second aspect of the invention provides a method of supplying sets of ultrasonic drive signals to a plurality of associated ultrasonic sources having different locations and/or directions with respect to each other as claimed in claim 11. Advantageous embodiments are defined in the dependent claims.

The audio/visual system comprises a display device, an audio processor and a plurality of ultrasonic sound sources. The display device displays a plurality of different video signals representing different video content. For example, a main video signal and a PIP video signal are displayed, wherein the PIP video signal overlays the main video signal. Of course any other different video signals may be displayed. The different video signals may also be displayed non-overlapping.

The audio processor receives audio input signals which correspond to the plurality of different video signals and drives the ultrasonic sound sources with ultrasonic drive signals. The audio input signals correspond to the plurality of different base-band audio contents. For example, if the main video signal is a TV or DVD signal, the corresponding base-band audio content may comprise a stereo audio signal which comprises two audio channels, or a 5.1 multi-channel audio signal which comprises 6 audio channels, respectively. Thus, each of the audio input signals has a specific content which differs from the other audio input signals because it is related to different video content. Each one of the audio input signals may be a single (mono) audio signal, or may comprise a set of audio signals. The base-band audio signals of the set are also referred to as the audio channels or base-band audio signals.

Each one of the audio input signals has to be processed to drive an ultrasonic source. The audio input signals are modulated on corresponding sets of a first and a second ultrasonic drive signal to obtain difference frequencies between the corresponding first and the second ultrasonic drive signals which are the associated base-band audio content. Thus, for each base-band audio signal of each set, a first and a second ultrasonic drive signal are generated such that the difference frequency of this first and second ultrasonic drive signal is this base-band audio signal. For example, as defined in claim 4, preferably the first ultrasonic drive signal is an ultrasonic carrier which has a fixed frequency, and the second ultrasonic drive signal is the difference of this carrier frequency and the base-band audio signal. The second ultrasonic drive signal may, for example, be obtained by mixing the carrier with the base-band audio channel and low-pass filtering the result.

The first ultrasonic drive signal may be identical for every one of base-band audio signals. Alternatively, different first ultrasonic drive signals may be used in that the carrier frequencies differ, or in that at least part of the base-band audio signal is modulated on both the first and the second ultrasonic drive signals. What counts is that the difference frequency of the first and the second ultrasonic drive signals is the base-band audio signal, such that a mixing of these two ultrasonic drive signals gives rise to a difference frequency which is the base-band audio signal.

The plurality of ultrasonic drive signals is supplied to an associated plurality of ultrasonic sources. Each ultrasonic source receives the corresponding sets of ultrasonic drive signals. The ultrasonic sources supply ultrasonic beams conveying the plurality of different audio input signals. At least a subset of the ultrasonic sources has different positions and/or directions with respect to each other to direct the different ultrasonic carriers of the subset to different listening positions. Thus, at least for the sub-set of the different audio contents, these different audio contents are conveyed by the ultrasonic beams to specific different listening positions. Because the base-band audio signal which is modulated on the ultrasonic beams is kept within this beam, the interference of these differently directed beams at the different listening positions will be minimal.

The product information brochure “HSS directed audio sound system, model series 220” of American Technology Corporation, San Diego, USA, discloses a technology which produces sound indirectly in the air by projecting a directional beam of modulated hypersonic sound into the air. The ultrasonic frequencies itself are inaudible. The sound is actually created as a byproduct of the interaction of the air molecules and the modulated ultrasonic frequencies. The audible acoustical sound wave is caused by the air down-converting (mixing) the ultrasonic frequencies to a lower frequency which can be heard. Since the audible sound is produced inside the beam of ultrasonic frequencies (which is highly directional), an important byproduct of this process is that the audible sound can be tightly focused in any direction within the listening environment. The brochure further discloses application of this technology to create a single focused sound beam. If a person is within the beam, he hears the audible sound. If the person is outside the beam, he will not hear the sound. In one application this beam is used in front of a museum display to provide the sound only to persons directly in front of the display.

It has to be noted that this brochure does not disclose how to use this technology in an audio/visual context to convey different audio signals belonging to different video contents by using differently positioned and/or directed ultrasound transducers to different persons at different positions in a same room.

EP-A-1073270 discloses an apparatus for navigation through multimedia presentations. Current multimedia applications assume that the human user can exploit visual information originating from semantically independent sources. This motivates the design of devices providing picture-in-picture information, navigation interfaces, which are known as electronic program guides in the television domain. Instead of constraining the use of audio information in such multimedia applications to make available the audio signal of the main presentation or the audio signal of the currently selected item in a navigation interface only, now a plurality of corresponding audio signals is reproduced. The reproduced audio signals correspond to those presentations that are currently in the focus of attention of a navigation control device or a user. The different audio signals are reproduced by different loudspeakers to a single listener.

In an embodiment in accordance with the invention as defined in claim 2, both the first and the second ultrasonic drive signals are supplied to a single ultrasonic transducer. This transducer produces an ultrasonic beam comprising both the frequency spectrum of the first and the second ultrasonic drive signals. As these spectra mix in the air, the difference frequency which is the audio base-band content will become audible inside the beam. As the ultrasonic beam is focused, it is possible to keep the audio base-band content in a small volume within the room. Outside this volume, the base-band audio conveyed by the beam is not audible. If, for example, two different base-band signals associated with two different video signals have to be audible each to a different person at a different location, the ultrasonic transducers have to be positioned and directed such that there ultrasonic beams point to the different locations, respectively. The ultrasonic transducers may be located immediately adjacent to each other and have an appropriate angle with respect to each other. Alternatively, the ultrasonic transducers may be positioned the same as conventional loudspeakers, but care has to be taken that their beams direct in the correct direction to the different listening positions. Even alternatively, the ultrasonic transducers may be positioned such that their beams are reflected against reflectors or walls to reach the different listening positions.

In an embodiment in accordance with the invention as defined in claim 3, the ultrasonic source comprises two ultrasonic transducers. The first ultrasonic drive signal is supplied to the first one of the ultrasonic transducers, and the second ultrasonic drive signal is supplied to the second one of the ultrasonic transducers. The down mixing of the spectra in the ultrasonic beams now only occurs in overlapping volumes of the beams. If the ultrasonic transducers are positioned to produce beams which run substantially parallel but are slightly convergent, a relative large overlap is possible. If the ultrasonic transducers are spaced apart, and have an angle with respect to each other to obtain the overlap, the overlap of the bundles will be relatively small. The use of two transducers to convey the audio information allows more flexibility in selecting the volume wherein this audio signal becomes audible. It is possible to obtain more complex distributions of the volumes wherein the sound is audible by using an array instead of two ultrasonic transducers. Again, the actual position and angle of the ultrasonic transducers has to be selected such that the ultrasonic beams are directed towards the correct listening positions.

In an embodiment in accordance with the invention as defined in claim 4, the first ultrasonic drive signal has a carrier frequency and the second ultrasonic drive signal has the carrier frequency minus the associated base-band frequencies of the audio content. The mixer and low-pass filter are only required to obtain the second ultrasonic drive signal. The first ultrasonic drive signal is the same carrier signal which is used to be mixed with the base-band audio content in the second ultrasonic drive signal.

In an embodiment in accordance with the invention as defined in claim 5, the different audio input signals comprise multi-channel audio signals. For example, the main audio may be a 5.1 multi-channel audio signal and the PIP audio may be a stereo signal. Of course, the different audio input signals may comprise several different multi-channel signals which have the same number of channels. It is also possible that an audio input signal is a mono signal. Instead of two, any number of multi-channel signals may be present.

Now, the ultrasonic sources comprise a plurality of ultrasonic transducers, one set for each one of the different multi-channel audio signals. Again, a single ultrasonic transducer, two or an array of ultrasonic transducers may be used per audio channel, dependent on the volume in space in which the sound of this audio channel should be audible. Thus, each set comprises a number of ultrasonic transducers in accordance with a number of channels of the associated multi-channel signal. The ultrasonic transducers of a first set are positioned and directed to point towards a same first listening position, and the ultrasonic transducers of at least one other set is positioned and directed to point towards another, second, listening position. Thus, the different multi-channel signals are audible at different listening positions, enabling two listeners to hear the different multi-channel audio content without mutual interference.

In an embodiment in accordance with the invention as defined in claim 6, both the display device and the audio processor are incorporated in a display apparatus. Thus, the display apparatus comprises the audio processor which generates the suitable ultrasonic drive signals and supplies these drive signals to outputs. The ultrasonic sources may not be incorporated in the display apparatus and thus may be positioned optimally. The use of ultrasonic sources of which the position is not bound to the position of the display apparatus increases the flexibility to obtain the desired volumes where the different sound signals should be audible. Further, many display apparatuses, such as for example, plasma and LCD displays, do not comprise loudspeakers and thus may also not include the ultrasonic sources.

In an embodiment in accordance with the invention as defined in claim 7, the display apparatus comprises the display device, the audio processor, and the plurality of ultrasonic sources. This has the advantage that all hardware to produce the different audio signals for the different listeners at the different positions is combined in one apparatus. It is not required to have separate loudspeaker boxes in the room. The loudspeakers boxes and their cables often are considered to be a nuisance, especially in 5.1 or 7.1 multi-channel systems.

In an embodiment in accordance with the invention as defined in claim 8, the position of the ultrasonic transducers is restricted such that it is not possible to direct the ultrasonic beams to the desired listening positions directly. Ultrasonic reflectors are used which are positioned with respect to the listening positions and the position of the ultrasonic transducers such that the reflected ultrasonic beams are correctly directed towards the listening positions.

In an embodiment in accordance with the invention as defined in claim 9, several ultrasonic reflectors are present to direct the ultrasonic beams of ultrasonic reflectors which are located in a same housing to the listening positions.

These and other aspects of the invention are apparent from and will be elucidated with reference to the embodiments described hereinafter.

### BRIEF DESCRIPTION OF THE DRAWINGS

In the drawings:

FIG. 1 shows a block diagram of an audio/visual system in accordance with the invention,

FIG. 2 shows schematically an audio/visual system in which two ultrasound transducers are used to direct two different mono audio signals, which are associated with two different video signals displayed on a display device, to two different listening positions,

FIG. 3 shows schematically an audio/visual system in which each one of the two different mono audio signals is generated by two displaced ultrasound transducers,

FIG. 4 shows schematically an audio/visual system in which two stereo signals are directed to two different listening positions, and

FIG. 5 shows schematically an audio/visual system in which a multi-channel audio signal is directed to an audience via ultrasonic reflectors.

### DETAILED DESCRIPTION OF THE PREFERRED EMBODIMENT

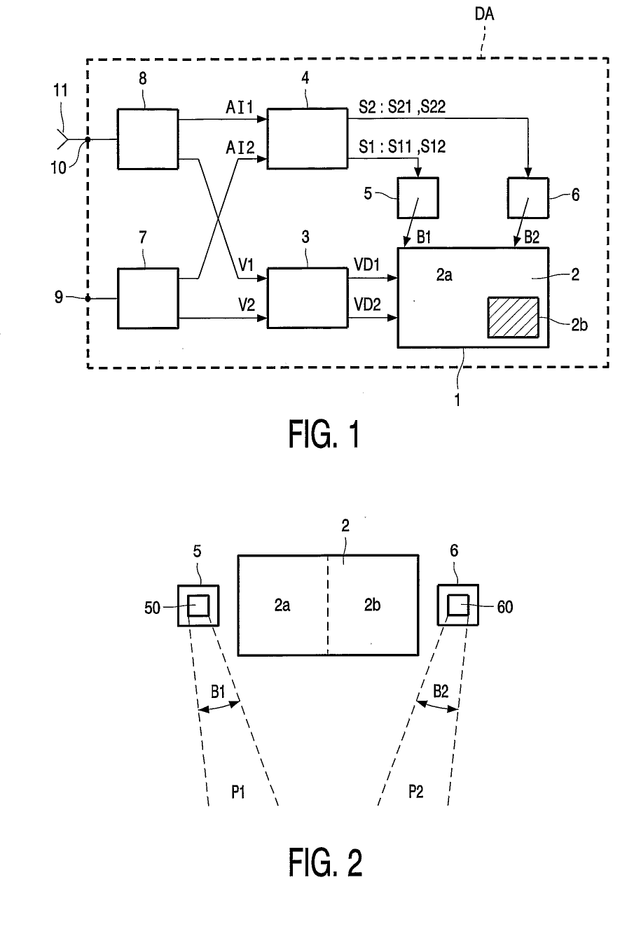

FIG. 1 shows a block diagram of an audio/visual system in accordance with the invention. The audio/visual system comprises a video processing circuit 3 which receives video input signals V1, V2 to supply video drive signals VD1, VD2 to a display device 1. The video input signals V1, V2 originate from different content sources. For example, the video input signal V1 may be a television broadcast video signal, and the video input signal V2 may be a VTR video signal. The video input signals V1, V2 may be analog or digital signals. The digital signals may originate from internet.

The different video input signals V1, V2 are displayed on different areas 2a, 2b of a display screen 2 of the display device 1. For example, the television broadcast video signal is displayed on the area 2a, while the VTR video signal is displayed on the area 2b. The area 2b may overlap the underlying television broadcast signal as shown in FIG. 1. The areas 2a and 2b may also be non-overlapping.

An audio input signal AI1 is associated with the video input signal V1, or said differently, the audio input signal AI1 belongs to the same content as the video input signal V1. The audio input signal AI2 is associated with the video input signal V2. Thus, for example, the audio input signal AI1 is a stereo audio signal accompanying the TV video broadcast video signal V1, and the audio input signal AI2 is a stereo audio signal accompanying the VTR video signal V2. If the video input signal V2 originates, for example, from a DVD player, the audio input signal AI2 may be a multi-channel (for example, 5.1 or 7.1) audio signal. The term audio channels is used to indicate the individual audio channels in an audio signal. For example, a stereo audio signal has two audio channels, a 5.1 multi-channel audio signal has 6 audio channels including a sub-woofer channel.

The audio processor 4 receives the audio input signals AI1 and AI2 to supply two sets S1, S2 of each a first and second ultrasonic drive signal S11, S12 and S21, S22, respectively. More in general, the set i or all the sets collectively are also referred to as Si and the first and second ultrasonic drive signal of the set i or of all the sets collectively are also referred to as S1i, S2i. Thus, the index i is used to indicate the preceding reference collectively or as the i^{th} term of this reference. If the index i has an integer value, a specific reference is indicated.

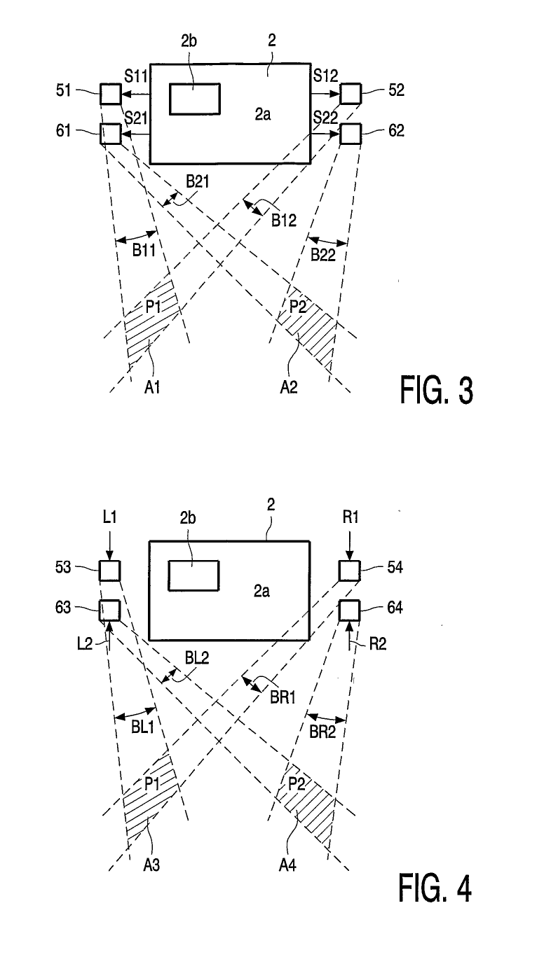

The audio processor 4 comprises a modulator or mixer (not shown) for each one of the audio channels of the different audio input signals AI1, AI2 to generate the sets S1, S2 of the first and the second ultrasonic drive signals per audio channel. Thus, in the two channel embodiment shown, the first and second ultrasonic drive signals are S11, S12 for the single audio channel of the audio input signal AI1, and S21, S22 for the single audio channel of the audio input signal AI2. The modulator modulates a carrier frequency, which has an ultrasonic frequency, with the base-band audio signal of the audio channel on the ultrasonic drive signals. Preferably, one of the ultrasonic drive signals S11; S21 of each set S1, S2 is selected to be the carrier frequency. The other ultrasonic drive signal S12; S22 of each set S1, S2 comprises the carrier frequency which is mixed with the base-band audio signal of the corresponding channel. The mixed signal is low-pass filtered to suppress the sum-frequencies occurring during the mixing. Thus, this other ultrasonic drive signal S12; S22 comprises the difference frequencies of the carrier frequency and the corresponding base-band audio signal. Consequently, if the first and the second ultrasonic drive signal S11, S12 and S21, S22 are mixed, the base-band audio signal would be one of the mixing components. Therefore, if the first and second ultrasonic drive signals S11, S12 are present in a single ultrasonic beam B1, the mixing of the frequencies of the ultrasonic drive signals S11, S12 in the air will cause the difference frequency which is the base-band audio signal to become audible. If the first ultrasonic drive signal S11 is conveyed by a first ultrasonic beam B11 (see FIG. 3) and the second ultrasonic drive signal S12 is conveyed by a second ultrasonic beam B12, the mixing only occurs in an overlapping volume of both these ultrasonic beams B11 and B12.

The first and the second ultrasonic drive signal S11, S12 and S21, S22 are supplied to a first and a second ultrasonic source 5, 6, respectively. The ultrasonic source 5 may comprise a single ultrasonic transducer 50 (see FIG. 2), two ultrasonic transducers 51, 52 (see FIG. 3), or an array of ultrasonic transducers. In FIG. 1, the ultrasonic source 5 receives the ultrasonic drive signals S11 and S12 to generate an ultrasonic beam B1, and the ultrasonic source 6 receives the ultrasonic drive signals S21 and S22 to generate an ultrasonic beam B2. The operation of this embodiment is further elucidated with respect to FIG. 2.

In FIG. 1, by way of example, the display device 1, the video processing circuit 3, the audio processor 4, and the ultrasonic sources 5, 6 are incorporated in a display apparatus DA. The display apparatus DA further comprises a tuner 8 and an interface circuit 7. The tuner 8 has an input 10 to be connected to an antenna or cable system 11 to receive broadcast TV signals. The tuner 8 supplies the video input signal V1 and the base-band audio input signal AI1 which usually comprises two (stereo) audio channels. The interface circuit 7 has an input 9 to receive an external video signal and audio signal, for example from a TVR, DVD or other peripheral apparatus. The interface circuit 7 supplies the video input signal V2 and the base-band audio input signal AI2 which usually comprises stereo or multi-channel audio.

Alternatively, the display apparatus may comprise a first and second tuner, the first tuner supplying the video input signal V1 and the second tuner supplying the video input signal V2.

The display apparatus DA may be a television receiver. The display apparatus DA may also be a monitor. Usually, the monitor DA does not comprise the tuner 8. If the monitor DA is used in an audio video/system in which the audio processing 4 and the ultrasonic transducers 5, 6 are not incorporated in the monitor DA, inputs are required to receive the different video input signals V1 and V2. Alternatively, these video input signals V1 and V2 may be combined in a single data stream, and only a single input is required. If the display apparatus DA is used as a computer monitor, usually, a combined video signal is supplied by the computer which comprises the different video input signals V1 and V2. The computer monitor DA may or may not comprise the audio processor 4. Further, the computer monitor DA may or may not comprise the ultrasonic sources. For example only, the invention can be used advantageously in combination with a computer monitor DA to display two images for two players, each player only receiving the sound belonging to its image.

FIG. 2 shows schematically an audio/visual system in which two ultrasound transducers are used to direct two different mono audio signals, which are associated with two different video signals displayed on a display device, to two different listening positions.

The different video signals V1 and V2 are displayed on the areas 2a and 2b of the screen 2, respectively. The areas 2a and 2b, for example, correspond with a left half and a right half of the screen 2.

The ultrasonic source 5 comprises a single ultrasonic transducer 50, both the first and the second ultrasonic drive signal S11, S12 are supplied to the single ultrasonic transducer 50. This transducer 50 produces an ultrasonic beam B1 which comprises both the frequency spectrum of the first and the second ultrasonic drive signals S11 and S12. As these spectra mix in the air, the difference frequency which is the audio base-band content will become audible inside the ultrasonic beam B1. Outside the volume occupied by the ultrasonic beam B1 no sound will be heard because the ultrasound frequencies are absent. If the first ultrasonic drive signal S11 is a carrier, its frequency spectrum only contains the frequency of this carrier.

The ultrasonic source 6 comprises a single ultrasonic transducer 60, both the first and the second ultrasonic drive signal S21, S22 are supplied to the single ultrasonic transducer 60. This transducer 60 produces an ultrasonic beam B2 which comprises both the frequency spectrum of the first and the second ultrasonic drive signals S21 and S22. As these spectra mix in the air, the difference frequency which is the audio base-band content will become audible inside the beam. If the first ultrasonic drive signal S21 is a carrier its frequency spectrum only contains the frequency of this carrier.

Consequently, the ultrasonic beams B1 and B2, which are directed towards the different positions P1 and P2 will produce the corresponding audible sound only within their beams. As long as the positions P1 or P2 are selected within the beams B13 and B2, respectively, but not in a volume where these beams B1 and B2 overlap, the different listeners hear only the sound associated with the video content of the video input signals V1 or V2 they are interested in.

Although in FIG. 2, the ultrasonic transducers 50, 60 are positioned at the left and right side of the screen 2, they may also be positioned above or below the screen 2. They may even be positioned directly adjacent to each other.

FIG. 3 shows schematically an audio/visual system in which the two different mono audio signals each are generated by two displaced ultrasound transducers.

The different video signals V1 and V2 are displayed on the areas 2a and 2b of the screen 2, respectively.

The ultrasonic source 5 now comprises two ultrasonic transducers 51, 52 to produce audible audio for a single audio channel. The first ultrasonic drive signal S11 is supplied to the first ultrasonic transducer 51, and the second ultrasonic drive signal S12 is supplied to the second ultrasonic transducer 52. The down mixing of the spectra in the respective ultrasonic beams B11 and B12 now only occurs in their overlapping volume A1 which is hatched. Because the ultrasonic transducers S11 and S12 are positioned spaced apart, for example at either side of the display screen 2, the ultrasonic beams B11 and B112 are quite convergent and the overlapping volume A1 is relatively small. If a larger overlapping volume A1 is required the ultrasonic transducers S11 and S12 should be positioned and/or directed to obtain less convergent ultrasonic beams B13 and B12. This might be relevant if several people should be addressed in the volume A1 with the same sound. Thus, the use of two transducers S11 and S12 to convey the audio base-band signal allows more flexibility in selecting the volume A1 where this audio signal becomes audible. It is possible to obtain more complex distributions of the volumes wherein the sound is audible by using an array instead of two ultrasonic transducers S11 and S12.

The ultrasonic source 6 now also comprises two ultrasonic transducers 61, 62 to produce audible audio for again a single but now other audio channel. The first ultrasonic drive signal S21 is supplied to the first ultrasonic transducer 61, and the second ultrasonic drive signal S22 is supplied to the second ultrasonic transducer 62. The down mixing of the spectra in the respective ultrasonic beams B21 and B22 only occurs in their overlapping volume A2 which also is hatched. Because the ultrasonic transducers S21 and S22 are positioned spaced apart, for example at either side of the display screen 2, the ultrasonic beams B21 and B22 are quite convergent and the overlapping volume A2 is relatively small. If a larger overlapping volume A2 is required the ultrasonic transducers S21 and S22 should be positioned and/or directed to obtain less convergent ultrasonic beams B21 and B22.

As is clear from FIG. 3, it is possible to create two non-overlapping volumes A1 and A2. The person P1 which has its ears in the volume A1 only hears the audio input signal AI1, and the person P2 which has its ears in the volume A2 only hears the audio input signal AI2.

FIG. 4 shows schematically an audio/visual system in which two stereo signals are directed to two different listening positions.

The different video signals V1 and V2 are displayed on the areas 2a and 2b of the screen 2, respectively.

The ultrasonic source 5 (not shown) now comprises two ultrasonic transducers 53, 54 to produce audible audio for two audio channels left L1 and right R1, respectively, of a stereo audio signal belonging to the video signal V1. The transducer 53 produces the ultrasonic beam BL1 for the left channel L1 in the same manner as elucidated with respect to FIG. 2. The transducer 54 produces the ultrasonic beam BR1 for the right channel R1 also in the same manner as elucidated with respect to FIG. 2. The beams BL1 and BR1 are directed to the volume A3 wherein at least the ears of the listener P1 are present.

The ultrasonic source 6 (not shown) now comprises two ultrasonic transducers 63, 64 to produce audible audio for two audio channels left L2 and right R2, respectively, of a stereo audio signal belonging to the video signal V2. The transducer 63 produces the ultrasonic beam BL2 for the left channel L2 in the same manner as elucidated with respect to FIG. 2. The transducer 64 produces the ultrasonic beam BR2 for the right channel R2 also in the same manner as elucidated with respect to FIG. 2. The beams BL2 and BR2 are directed to the volume A4 wherein at least the ears of the listener P2 are present.

As is clear from FIG. 4, in the volume A3, only the audio channels L1 and R1 are audible, and in the volume A4, only the audio channels L2 and R2 are audible.

To improve the stereo image, the ultrasonic transducer 53 may be positioned further to the left of the display screen 2 and/or nearer to the listener P1. Preferably the angle at which the beam BL1 reaches the left ear of the person P1 is equal to the angle at which the beam BR1 reaches the right ear of the person P1 when this person is looking to the video information V1 displayed on the area 2a of the display screen 2.

A similar setup is possible if an audio input signal AIi comprises more than two audio channels. In such a setup, for every audio channel of the audio input signal AIi one (see FIG. 2) or two (see FIG. 3) ultrasonic transducers are used, which are positioned and directed suitably to obtain the desired directionality of the audio channels. A possible positioning may be equal to the positioning of conventional loudspeakers. However, the ultrasonic transducers should be directed carefully to obtain ultrasonic beams which cover the correct volume around the intended listening positions P1, P2.

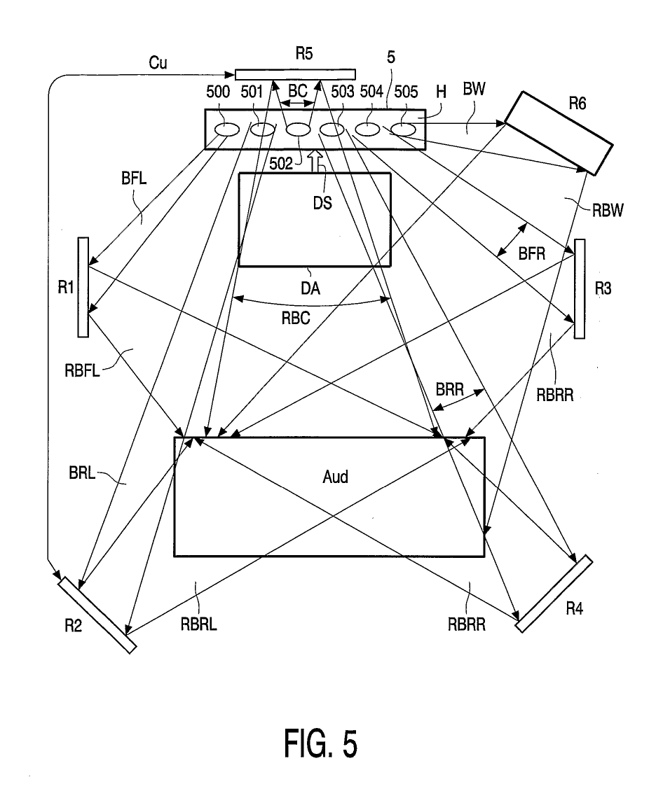

FIG. 5 shows schematically an audio/visual system in which a multi-channel audio signal is directed to an audience via ultrasonic reflectors Ri (R1 to R6). By way of example, the multi-channel audio signal is a 5.1 signal (front left, center, front right, surround left, surround right, and subwoofer). The use of ultrasound reflectors Ri is not limited to these particular multi-channel signals and can also be used for stereo audio signals or 7.1 channel audio signals. The ultrasound reflectors Ri need not be present for every audio channel. For example, still a separate conventional loudspeaker may be used for the subwoofer. The use of ultrasound reflectors Ri is not limited to an audio/visual system 1 in which different audio content belonging to different video content has to be audible only, respectively, to different persons P1, P2 at different listening positions L1, L2. The ultrasound reflectors Ri may also be used advantageously in an audio/visual system 1 in which a single audio content (comprising the multi-channels of the same audio content) has to be directed to the whole audience.

An audio/video apparatus DA supplies the audio drive signals DS to the array of ultrasonic transducers 500 to 505, which, for example, all are incorporated in the same housing H. The ultrasonic transducers 500 to 505 may be present in a single housing separate from the audio/video apparatus DA, or in several separate housings. Alternatively, the ultrasonic transducers 500 to 505 may be accommodated in the audio/video apparatus DA. Their arrangement may differ from the one shown, for example, the ultrasonic transducers 500 and 501 may be arranged at the left side of the audio/video apparatus DA, and the ultrasonic transducers 503 and 504 may be arranged at the right side of the audio/video apparatus DA. The ultrasonic transducer 502 may be arranged on top of the display device (not shown) of the audio/video apparatus DA. The ultrasonic transducer 505 may be replaced by a conventional subwoofer loudspeaker system driven by a conventional loudspeaker drive signal.

The ultrasonic transducers 500 and 501 supply the ultrasonic beams BFL and BRL, respectively. The ultrasonic beam BFL conveys the front left audio channel, the ultrasonic beam BRL conveys the rear left audio channel also referred to as the left surround channel. The ultrasonic beam BFL is reflected by the ultrasonic reflector R1 to obtain the reflected beam RBFL, and the beam BRL is reflected by the ultrasonic reflector R2 to obtain the reflected beam RBRL. Both the reflected beam RBFL and RBRL reach the audience Aud from a desired direction fitting the associated audio channels conveyed by the ultrasonic transducers 500 and 501.

The ultrasonic transducers 504 and 503 supply the ultrasonic beams BFR and BRR, respectively. The ultrasonic beam BFR conveys the front right audio channel, the ultrasonic beam BRR conveys the rear right audio channel, also referred to as the right surround channel. The ultrasonic beam BFR is reflected by the ultrasonic reflector R3 to obtain the reflected beam RBFR, and the beam BRR is reflected by the ultrasonic reflector R4 to obtain the reflected beam RBRR. Both the reflected beam RBFR and RBRR reach the audience Aud from a desired direction fitting the associated audio channels conveyed by the ultrasonic transducers 504 and 503.

The ultrasonic transducers 502 and 505 supply the ultrasonic beams BC and BW, respectively. The ultrasonic beam BC, which conveys the audio centre channel, is reflected by the ultrasonic reflector R5 to obtain the reflected beam RBC, and the beam BW, which conveys the audio subwoofer channel is reflected by the ultrasonic reflector R6 to obtain the reflected beam RBW. The reflected beam RBC reaches the audience Aud from a desired front direction fitting the center audio channel conveyed by the ultrasonic transducer 502. The angle with which the reflected beam RBW reaches the audience Aud is not very important as this beam conveys the low frequencies of the subwoofer channel only.

As shown, all the ultrasound transducers 500 to 505 are incorporated in the same housing H.

Although the setup with ultrasound reflectors Ri is elucidated by using a single ultrasound transducer per audio channel, it is also possible to use two ultrasound transducers per audio channel, or to use a single ultrasound transducer per audio channel in combination with a common ultrasound transducer for two or more channels. The common transducer may generate a beam modulated only with the carrier frequency.

The ultrasonic reflectors Ri may advantageously be used in or together with an audio/video apparatus DA, which for example, may be a television apparatus, a computer monitor, a multi-channel receiver or amplifier, or a DVD player having the required processing for generating the drive signals DS. These drive signals DS may be the base-band audio channels or may be the sets Si of ultrasound drive signals as discussed with respect to FIG. 1. If the drive signals DS are the base-band audio channels, the processor 4 (see FIG. 1) has to be added as a separate unit or has to be provided in the housing of the ultrasound transducers 500 to 505.

It should be noted that the above-mentioned embodiments illustrate rather than limit the invention, and that those skilled in the art will be able to design many alternative embodiments without departing from the scope of the appended claims.

For example, preferably, the ultrasonic sources 5, 6 are controllable by the user such that the direction of the ultrasonic beams B1, B2; B11, B12, B21, B22; or BL1, BL2, BR1, BR2 can be selected at will. For example, the direction of the ultrasonic beams is controlled to be optimally aligned with the actual position of the ears of the user, even if this position changes. Preferably, the remote control can be used to control the direction of the ultrasonic beams.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An audio/visual system comprising
a display device (1) for displaying a plurality of different video signals (V1, V2) having different video content, and
an audio processor (4) for
(i) receiving a plurality of audio input signals (AI1, AI2) representing corresponding different base-band audio content, wherein each one of the different audio input signals (AI1, AI2) corresponds to a corresponding one of the plurality of different video signals (V1, V2), and
(ii) modulating the audio input signals (AI1, AI2) on corresponding sets (Si) of a first and a second ultrasonic drive signal (S1i, S2i) having a difference frequency being the corresponding base-band audio content, and
a plurality of ultrasonic sources (5, 6), for receiving the corresponding sets (Si) of first and second ultrasonic drive signals (S1i, S2i), respectively, to supply a plurality of ultrasonic beams (Bi) conveying the plurality of different audio input signals (AI1, AI2), wherein at least a subset of the ultrasonic sources (5, 6) have different locations and/or directions with respect to each other to direct the different ultrasonic beams (Bi) of the ultrasonic sources (5, 6) of the subset to different listening positions (P1, P2).

2. An audio/visual system as claimed in claim 1, wherein at least one of the ultrasonic sources (5, 6) comprises a single ultrasonic transducer (50, 60) for receiving both the first and second ultrasonic drive signals (S1i, S2i).

3. An audio/visual system as claimed in claim 1, wherein for at least one of the sets (Si), the corresponding one of the ultrasonic sources (5) comprises
a first ultrasonic transducer (51) for receiving the first ultrasonic drive signal (S1i) to supply a first ultrasonic beam (B11), and
a second ultrasonic transducer (52) for receiving the second ultrasonic drive signal (S21) to supply a second ultrasonic beam (B12), and wherein the first ultrasonic transducer (51) and the second ultrasonic transducer (52) are positioned and directed to obtain an intersection of the first ultrasonic beam (B11) and the second ultrasonic beam (B12) at a particular one of the listening positions (P1).

4. An audio/visual system as claimed in claim 2, wherein the first ultrasonic drive signal (S1i) has a carrier frequency and the second ultrasonic drive signal (S2i) has the carrier frequency minus the associated base-band frequencies of the audio content.

5. An audio/visual system as claimed in claim 1, wherein the different audio input signals (AI1, AI2) comprise multi-channel signals (AI1, AI2), and wherein the ultrasonic sources (5, 6) comprise a plurality of ultrasonic transducers (53, 54; 63, 64), one set for each one of the different multi-channel audio signals (AI1, AI2), each set comprising a number of ultrasonic transducers in accordance with a number of channels of the associated one of the multi-channel signals, the ultrasonic transducers (53, 54) of a first set being positioned and directed to point towards a same first listening position (P1), and ultrasonic transducers (63, 64) of at least one other set being positioned and directed to point towards another listening position (P2).

6. An audio/visual system as claimed in claim 1, wherein both the display device and the audio processor (4) are incorporated in a display apparatus (DA).

7. An audio/visual system as claimed in claim 1, wherein the display device (1), the audio processor (4), and the plurality of ultrasonic sources (5, 6) all are incorporated in or mechanically attached to a display apparatus (DA).

8. An audio/visual system as claimed in claim 2, wherein the audio/visual system further comprises at least one ultrasonic reflector (Ri) for reflecting an associated one of the ultrasonic beams (Bi), the at least one ultrasonic reflector (Ri) being positioned with respect to at least one (P1) of the different listening positions (P1, P2) and at least one of the ultrasonic transducers (50, 60; 51, 52, 61, 62) to direct the associated ultrasonic beam (Bi) to the at least one (P1) of the listening positions (P1, P2).

9. An audio/visual system as claimed in claim 1, wherein at least one of the different audio input signals (AI1, AI2) comprises a multi-channel signal (AI1) with a predetermined number of audio channels, and wherein an associated one (5) of the ultrasonic sources (5, 6) comprises a number of ultrasonic transducers (500, 501, 502, 503, 504, 505) in accordance with the number of audio channels, at least a subset of two of the ultrasonic transducers (500, 501, 502, 503, 504, 505) being arranged in a common housing (H), and wherein the audio/visual system further comprises ultrasonic reflectors for reflecting ultrasonic sound, the ultrasonic reflectors being positioned with respect to at least one (P1) of the different listening positions (P1, P2) and the ultrasonic transducers (500, 501, 502, 503, 504, 505) of the subset to direct their ultrasonic beams (Bi) to the at least one (P1) of the listening positions (P1, P2).

10. An audio/visual system as claimed in claim 8, wherein the display device (1), the audio processor (4), and the plurality of ultrasonic sources (5, 6) all are incorporated in or mechanically attached to a cabinet of a display apparatus (DA).

11. A method of supplying sets (Si) of ultrasonic drive signals (S1i, S2i) to a plurality of associated ultrasonic sources (5, 6) having different locations and/or directions with respect to each other to direct different ultrasonic beams (Bi) of a subset of the sets (Si) to different listening positions (P1, P2), the method comprises
displaying (1) a plurality of different video signals (V1, V2) having different video content, and
receiving (4) a plurality of audio input signals (AI1, AI2) representing a plurality of corresponding different base-band audio contents, wherein each one of the different audio input signals (AI1, AI2) corresponds to a corresponding one of the plurality of different video signals (V1, V2),
modulating the audio input signals (AI1, AI2) on corresponding sets (Si) of the first and a second ultrasonic drive signal (S1i, S2i) having a difference frequency being the associated base-band audio content, and
supplying (5, 6) a plurality of ultrasonic beams (Bi) conveying the plurality of different audio input signals (AI1, AI2), wherein at least a subset of the ultrasonic sources (5, 6) have different positions and/or directions with respect to each other to direct the different ultrasonic beams (Bi) of the subset to different listening positions (P1, P2).
